(19) United States
(12) Patent Application Publication
(10) Pub. No.: US 2024/0378843 A1
(43) Pub. Date: Nov. 14, 2024

(54) IMAGE PROCESSING METHOD AND OPERATION DEVICE

(71) Applicant: MEDIATEK INC., Hsin-Chu (TW)

(72) Inventors: Han-Yang Wang, Hsinchu City (TW); Yu-Chun Chen, Hsinchu City (TW); Chia-Ping Chen, Hsinchu City (TW); Ying-Jui Chen, Hsinchu City (TW); Chi-Cheng Ju, Hsinchu City (TW)

(73) Assignee: MEDIATEK INC., Hsin-Chu (TW)

(21) Appl. No.: 18/659,014

(22) Filed: May 9, 2024

Related U.S. Application Data
(60) Provisional application No. 63/501,153, filed on May 10, 2023.

(51) Int. Cl. G06V 10/25; G06T 3/40; G06T 5/70; G06T 7/11

(52) U.S. Cl. CPC G06V 10/25; G06T 3/40; G06T 5/70; G06T 7/11; G06T 2207/30168

(57) ABSTRACT

An image processing method is applied to an operation device and includes analyzing an unprocessed image to split the unprocessed image into a first region and a second region, applying a first image processing algorithm to the first region for acquiring a first processed result, applying a second image processing algorithm different from the first image processing algorithm to the second region for acquiring a second processed result, and generating a processed image via the first processed result and the second processed result.

### CROSS REFERENCE TO RELATED APPLICATIONS

This application claims the benefit of U.S. Provisional Application No. 63/501,153, filed on May 10, 2023. The content of the application is incorporated herein by reference.

### BACKGROUND

When the video or images are processed by the complex image processing methods, such as convolutional neural network, high dynamic range technology or any quality enhancement technology, the full frame of the video or the images are processed by the same complex image processing method, thereby needing high computational resource and wasting a long-term processing period. Conventional image operation device that applies the same complex image processing method for the full frame of the video or the images has drawbacks of the long-term processing period and high computation and cost. Therefore, design of an image processing device of applying the high cost method for a part of the image for computation economy is an important issue in the image apparatus industry.

### SUMMARY

The present invention provides an image processing method of dynamically estimating ROI for computational efficiency and a related operation device for solving above drawbacks.

According to the claimed invention, an image processing method includes analyzing an unprocessed image to split the unprocessed image into a first region and a second region, applying a first image processing algorithm to the first region for acquiring a first processed result, applying a second image processing algorithm different from the first image processing algorithm to the second region for acquiring a second processed result, and generating a processed image via the first processed result and the second processed result.

According to the claimed invention, the image processing method further includes setting at least one region of interest inside the unprocessed image as the first region, and defining a remaining region inside the unprocessed image outside the at least one region of interest as the second region, or defining all region inside the unprocessed image as the second region. Computation power of the first image processing algorithm is greater than computation power of the second image processing algorithm.

According to the claimed invention, the image processing method further includes increasing a first image quality of the first region by the first image processing algorithm to acquire the first processed result, and maintaining a second image quality of the second region by the second image processing algorithm to acquire the second processed result or enhancing a second image quality of the second region by the second image processing algorithm to acquire the second processed result, wherein the first image quality is greater than or different from the second image quality.

According to the claimed invention, the image processing method further includes setting the first processed result acquired by the first image processing algorithm applied to the first region as prior information, and the second image processing algorithm enhancing an image quality of the second region in accordance with the prior information to acquire the second processed result.

According to the claimed invention, the image processing method further includes adjusting a number or a size of the first region in accordance with a preset condition. The image processing method is applied to an operation device, and the preset condition is computation constraint of the operation device or a target feature inside the unprocessed image. The preset condition is the ever-changing computation constraint, and the image processing method adjusts the first region in accordance with a manually-input control command or a control command automatically analyzed by the preset condition.

According to the claimed invention, the image processing method further includes utilizing a smooth algorithm to merge the first processed result and the second processed result for eliminating noncontiguous artifact of the processed image.

According to the claimed invention, an operation device includes operation processor electrically connected with an image sensor to acquire an unprocessed image, and adapted to analyze the unprocessed image to split the unprocessed image into a first region and a second region, apply a first image processing algorithm to the first region for acquiring a first processed result, apply a second image processing algorithm different from the first image processing algorithm to the second region for acquiring a second processed result, and generate a processed image via the first processed result and the second processed result.

The image processing method and the operation device of the present invention can dynamically estimate and process the ROI within the unprocessed image, instead of the entire frame of the unprocessed image; because the ROI is particularly focused on in the image processing method for preferred economy of the computational source and quality improvement at the same time. The number and the size of the ROI can be adjusted based on the computation constraint of the operation device or the target feature inside the unprocessed image, for adaption of the ever-changing computation constraint in the real application. The smooth algorithm can be applied to merge the processed ROI and the low processed or unprocessed non-ROI for preventing the processed image from noncontiguous artifact; the processed ROI can further be the prior information of the low processed non-ROI for quality enhancement, so the present invention provides three related embodiments as mentioned above. Comparing to the prior art, the present invention can split the unprocessed image into the ROI and the non-ROI, and the ROI can be dynamically estimated; the first image processing algorithm with the high computation power can be applied for the ROI, and the second image processing algorithm with the low computation power can be applied for the non-ROI or the full frame of the unprocessed image, and the processed ROI for the first image quality and the low processed or unprocessed non-ROI or full frame for the second image quality can be merged via the smooth algorithm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an operation device according to an embodiment of the present invention.

FIG. 2 is a flow chart of an image processing method according to the embodiment of the present invention.

FIG. 3 is a diagram of variation of the unprocessed image according to a first embodiment of the present invention.

FIG. 4 is a diagram of variation of the unprocessed image according to a second embodiment of the present invention.

FIG. 5 is a diagram of variation of the unprocessed image according to a third embodiment of the present invention.

### DETAILED DESCRIPTION

Please refer to FIG. 1. FIG. 1 is a functional block diagram of an operation device 10 according to an embodiment of the present invention. The operation device 10 can be applied for a camera or a smart phone, or any electronic device that can capture images. The operation device 10 can dynamically estimate at least one region of interest (ROI) within the captured image, and process the ROI instead of the entire image, so as to improve an image quality of the ROI without spending large computational resources for computation economy of the operation device 10.

The operation device 10 can include an operation processor 12 electrically connected with an image sensor 14. The image sensor 14 may be a built-in element of the operation device 10, or may be an element independent from the operation device 10, which depends on a design demand. The image sensor 14 can capture at least one unprocessed image relevant to a surveillance area of the camera or the smart phone or the driving recorder where inside the operation device 10 is disposed, practical application of the image sensor 14 is not limited to the foresaid embodiments, and a detail is omitted herein for simplicity; the unprocessed image can be interpreted as an original image that is not calibrated by dynamic ROI estimation of the present invention. The operation processor 12 can acquire the unprocessed image from the image sensor 14 to execute the dynamic ROI estimation as mentioned above for the preferred computation economy.

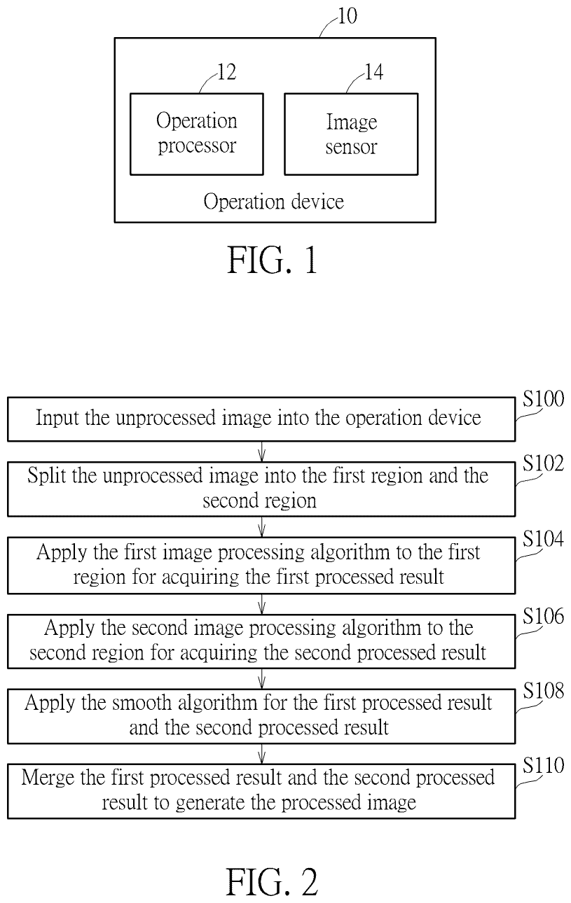

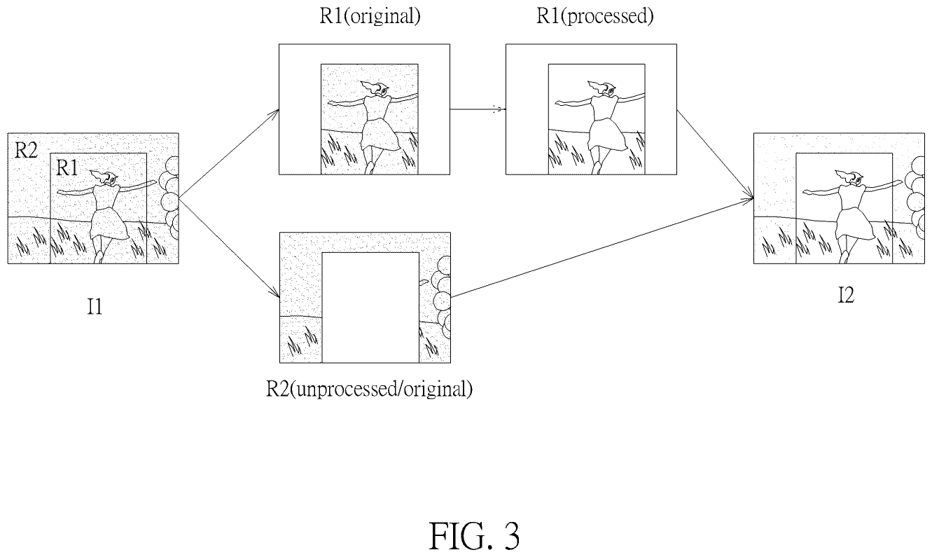

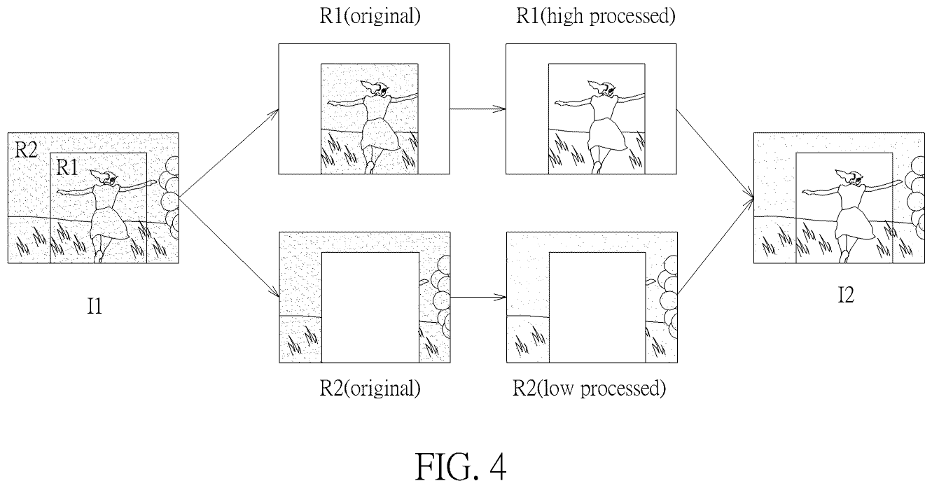

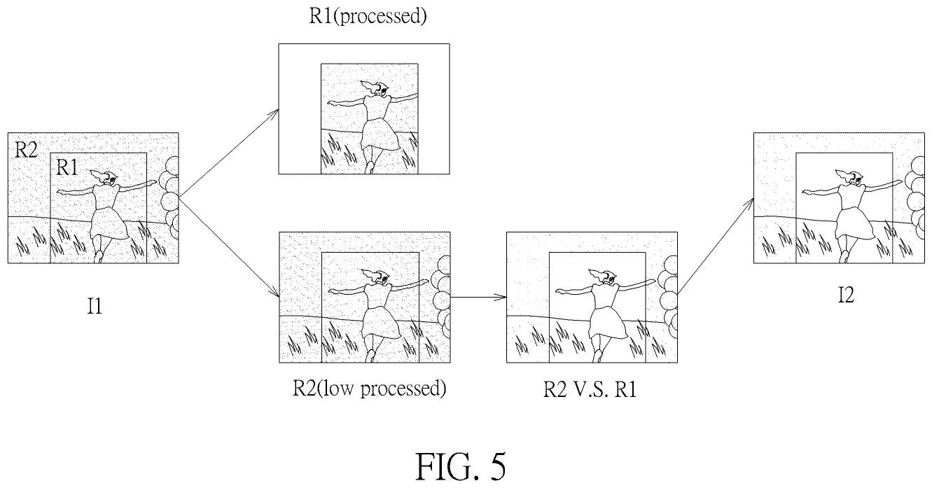

Please refer to FIG. 2 to FIG. 5. FIG. 2 is a flow chart of an image processing method according to the embodiment of the present invention. FIG. 3 is a diagram of variation of the unprocessed image I1 according to a first embodiment of the present invention. FIG. 4 is a diagram of variation of the unprocessed image I1 according to a second embodiment of the present invention. FIG. 5 is a diagram of variation of the unprocessed image I1 according to a third embodiment of the present invention. The image processing method illustrated in FIG. 2 can be suitable for the operation device 10 shown in FIG. 1.

In the first embodiment, step S100 and step S102 can be executed to input the unprocessed image I1 into the operation device 10, and analyze the unprocessed image I1 to split the unprocessed image I1 into a first region R1 and a second region R2. In the present invention, the image processing method can set the ROI inside the unprocessed image I1 as the first region R1, and then define a remaining region inside the unprocessed image I1 outside or except the ROI as the second region R2. The image processing method can detect a motion object or a center area or an object with a specific feature inside the unprocessed image I1 to set as the ROI; definition of the ROI is not limited to the foresaid embodiment, and depends on the design demand.

Then, step S104 and step S106 can be executed to apply a first image processing algorithm to the first region R1 for acquiring a first processed result that increases a first image quality of the first region R1, and apply a second image processing algorithm to the second region R2 for acquiring a second processed result that maintains a second image quality of the second region R2; the first image processing algorithm can be different from the second image processing algorithm, and computation power of the first image processing algorithm can be greater than computation power of the second image processing algorithm, so the first image quality can be optionally greater than the second image quality due to different processing effects of the first image processing algorithm and the second image processing algorithm. The processing effect of the first image processing algorithm can be designed in accordance with a customized demand. As shown in FIG. 3, the original first region R1 which is blurry is processed by the first image processing algorithm to generate the processed first region R1 (which means the first processed result with the increased first image quality). The second image processing algorithm can be defined as not improving the image quality; so that the unprocessed/original second region R2 that is processed (or skipped) by the second image processing algorithm can maintain the second image quality (which means the second processed result having the original image quality in the unprocessed image I1).

Final, step S108 and step S110 can be executed to apply a smooth algorithm for the first processed result and the second processed result, and merge the first processed result (which means the processed first region R1) and the second processed result (which means the unprocessed second region R2) to generate a processed image 12 without noncontiguous artifact between the first region R1 (ROI) and the second region R2 (non-ROI). In step S108, pixel values between boundaries of the first region R1 and the second region R2 can be adjusted to remain continuity and natural; in step S110, the processed first region R1 may be embedded in empty space of the unprocessed second region R2 for merge. The smooth algorithm and a merge algorithm can be any common technology, and a detailed description is omitted herein for simplicity.

In step S102, the present invention may have a concept of scalability that the image processing method can adjust a number or a size of the first region R1 in accordance with a preset condition to adapt to the ever-changing computation constraint in real application. The preset condition can be, but not limited to, low bandwidth, low power, low computation or any applicable factors based on the ever-changing computation constraint. In one possible embodiment, the operation device 10 may have fewer computation constrains, and the image processing method can select several ROIs within the unprocessed image I1 in accordance with the actual demand. In another possible embodiment, the operation device 10 has the computation constraint (i.e. the budget is tight or the environment or the computation conforms to a specific condition), and the image processing method can decrease the number of the ROI and/or extract the ROI into the smaller one based on the ever-changing computation constraint for overcoming the computation constraint.

Therefore, when the operation device 10 has the computation constraint, the preset condition or the computation constraint can be detected and analyzed to automatically generate the control command, and the image processing method can adjust the number or the size of the first region R1 in accordance with the automatically analyzed control command for scalability; in addition, when the operation device 10 has the computation constraint, the user may utilize an input interface (which can be a mouse or a keyboard not shown in the figures) of the operation device 10 to manually input a control command, and the image processing method can adjust the number or the size of the first region R1 in accordance with the manually-input control command for scalability.

It should be mentioned that the preset condition can optionally be, but not limited to, a target feature inside the unprocessed image I1. For example, a moving object (such as the vehicle or the pedestrian) or a specific object (such as the human face, the human body or the pet) inside the unprocessed image I1 can be the target feature marked to set as the ROI, or an object located on a center region of the unprocessed image I1 can be the target feature marked to set as the ROI, or an object with specific color inside the unprocessed image I1 can be the target feature marked to set as the ROI. As if the environment is changed, a number of the moving object, or position of the object, or existence of the specific-color object can be used to dynamically adjust the number and/or the size of the first region R1.

In the second embodiment shown in FIG. 4, the first region R1 and the second region R2 can be split from the unprocessed image I1 for being applied by the related image processing algorithm via step S100, step S102 and step S104 as mentioned above. Then, step S106 can be changed and executed to apply the second image processing algorithm to the second region R2 for acquiring the second processed result that enhances the second image quality of the second region R2. The image processing method can utilize the first image processing algorithm (such as the high cost or high computation algorithm) to transform the original first region R1 into the high processed first region R1 with the improved first image quality, and further utilize the second image processing algorithm (such as the low cost or low computation algorithm) to transform the original second region R2 into the low processed second region R2 with the second image quality that is lower than or different from the first image quality. In some other embodiments, the first image processing algorithm is different from the second image processing algorithm for different image effects, different processes for different targets, or any other process to adjust vision-related factors, which should not be limited in this disclosure. Final, step S108 and step S110 can be executed that the high processed first region R1 (which means the first processed result) and the low processed second region R2 (which means the second processed result) can be smoothed and merged to generate the processed image 12 without the noncontiguous artifact.

In the third embodiment shown in FIG. 5, the ROI can be split from the unprocessed image I1, and the ROI can be defined as the first region R1, and the entire frame of the unprocessed image I1 can be defined as the second region R2 via step S100 and step S102. Then, step S104 can be changed and executed to apply the first image processing algorithm (such as the high cost or high computation algorithm) for the first region R1 to acquire the first processed result, and the first processed result can be set as prior information that is different from the first embodiment and the second embodiment. Then, step S106, step S108 and step S110 can be changed and executed to apply the second image processing algorithm (such as the low cost or low computation algorithm) for the second region R2 to acquire the second processed result, and the prior information (which means the first processed result) can be provided to the second processed result for enhancement of the image quality of the second region R2, by calibrating the second region R2 via parameters of the prior information, or by replace a central part of the second region R2 with the first processed result, so as to generate the processed image 12 via the smooth algorithm to prevent the noncontiguous artifact.

In conclusion, the image processing method and the operation device of the present invention can dynamically estimate and process the ROI within the unprocessed image, instead of the entire frame of the unprocessed image; because the ROI is particularly focused on in the image processing method for preferred economy of the computational source and quality improvement at the same time. The number and the size of the ROI can be adjusted based on the computation constraint of the operation device or the target feature inside the unprocessed image, for adaption of the ever-changing computation constraint in the real application. The smooth algorithm can be applied to merge the processed ROI and the low processed or unprocessed non-ROI for preventing the processed image from noncontiguous artifact; the processed ROI can further be the prior information of the low processed non-ROI for quality enhancement, so the present invention provides three related embodiments as mentioned above. Comparing to the prior art, the present invention can split the unprocessed image into the ROI and the non-ROI, and the ROI can be dynamically estimated; the first image processing algorithm with the high computation power can be applied for the ROI, and the second image processing algorithm with the low computation power can be applied for the non-ROI or the full frame of the unprocessed image, and the processed ROI for the first image quality and the low processed or unprocessed non-ROI or full frame for the second image quality can be merged via the smooth algorithm.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method comprising:
analyzing an unprocessed image to split the unprocessed image into a first region and a second region;
applying a first image processing algorithm to the first region for acquiring a first processed result;
applying a second image processing algorithm different from the first image processing algorithm to the second region for acquiring a second processed result; and
generating a processed image via the first processed result and the second processed result.

2. The image processing method of claim 1, further comprising:
setting at least one region of interest inside the unprocessed image as the first region; and
defining a remaining region inside the unprocessed image outside the at least one region of interest as the second region, or defining all region inside the unprocessed image as the second region;
wherein computation power of the first image processing algorithm is greater than computation power of the second image processing algorithm.

3. The image processing method of claim 1, further comprising:
increasing a first image quality of the first region by the first image processing algorithm to acquire the first processed result.

4. The image processing method of claim 3, further comprising:
maintaining a second image quality of the second region by the second image processing algorithm to acquire the second processed result.

5. The image processing method of claim 3, further comprising:
enhancing a second image quality of the second region by the second image processing algorithm to acquire the second processed result, wherein the first image quality is greater than or different from the second image quality.

6. The image processing method of claim 1, further comprising:
setting the first processed result acquired by the first image processing algorithm applied to the first region as prior information; and
the second image processing algorithm enhancing an image quality of the second region in accordance with the prior information to acquire the second processed result.

7. The image processing method of claim 1, further comprising:
adjusting a number or a size of the first region in accordance with a preset condition.

8. The image processing method of claim 7, wherein the image processing method is applied to an operation device, and the preset condition is computation constraint of the operation device or a target feature inside the unprocessed image.

9. The image processing method of claim 8, wherein the preset condition is the ever-changing computation constraint, and the image processing method adjusts the first region in accordance with a manually-input control command or a control command automatically analyzed by the preset condition.

10. The image processing method of claim 1, further comprising:
utilizing a smooth algorithm to merge the first processed result and the second processed result for eliminating noncontiguous artifact of the processed image.

11. An operation device, comprising:
an operation processor electrically connected with an image sensor to acquire an unprocessed image, and adapted to analyze the unprocessed image to split the unprocessed image into a first region and a second region, apply a first image processing algorithm to the first region for acquiring a first processed result, apply a second image processing algorithm different from the first image processing algorithm to the second region for acquiring a second processed result, and generate a processed image via the first processed result and the second processed result.

12. The operation device of claim 1, wherein the operation processor is adapted to further set at least one region of interest inside the unprocessed image as the first region, and define a remaining region inside the unprocessed image outside the at least one region of interest as the second region, or define all region inside the unprocessed image as the second region; computation power of the first image processing algorithm is greater than computation power of the second image processing algorithm.

13. The operation device of claim 11, wherein the operation processor is adapted to further increase a first image quality of the first region by the first image processing algorithm for acquiring the first processed result.

14. The operation device of claim 13, wherein the operation processor is adapted to further maintain a second image quality of the second region by the second image processing algorithm for acquiring the second processed result.

15. The operation device of claim 13, wherein the operation processor is adapted to further enhance a second image quality of the second region by the second image processing algorithm for acquiring the second processed result, and the first image quality is greater than the second image quality.

16. The operation device of claim 11, wherein the operation processor is adapted to further set the first processed result acquired by the first image processing algorithm applied to the first region as prior information, and enhance an image quality of the second region in accordance with the prior information by the second image processing algorithm for acquiring the second processed result.

17. The operation device of claim 11, wherein the operation processor is adapted to further adjust a number or a size of the first region in accordance with a preset condition.

18. The operation device of claim 17, wherein the preset condition is computation constraint of the operation device, or a target feature inside the unprocessed image.

19. The operation device of claim 18, wherein the preset condition is the ever-changing computation constraint, and the operation processor is adapted to further adjust the first region in accordance with a manually-input control command or a control command automatically analyzed by the preset condition.

20. The operation device of claim 11, wherein the operation processor is adapted to further utilize a smooth algorithm to merge the first processed result and the second processed result for eliminating noncontiguous artifact of the processed image.
